(19) United States
(12) Patent Application Publication
(10) Pub. No.: US 2010/0027120 A1
(43) Pub. Date: Feb. 4, 2010

(54) Soft lens cover

(76) Inventor: Scott Elowitz, Freehold, NJ (US)

Correspondence Address: ARTHUR M. PESLAK, ESQ;Mandel & Peslak, LLC, Suite 5, 80 Scenic Drive, Freehold, NJ, 07728, US

(21) Appl. No.: 12/221,277

(22) Filed: Aug. 1, 2008

(51) Int. Cl. G02B 23/16

(52) U.S. Cl. 359/511; 396/448

(57) ABSTRACT

What is disclosed is a removable cover for a camera lens. The lens cover is generally circular and is adapted to cover the front element of a camera lens. The lens cover is fabricated from an elastic material so as to fit tightly on the end of a camera lens.

### BACKGROUND OF THE INVENTION

The present invention is directed to the field of photography equipment accessories. In particular, the present invention relates to a cap for the front of a camera lens. In particular, the present invention is directed to a cap that fits securely on the front of a camera lens to protect the lens from dirt, moisture, dust or impact damage.

### SUMMARY OF THE INVENTION

A removable camera lens cover adapted to cover the front element of a camera lens comprising a generally circular end cap; circular side walls connected to the generally circular end cap wherein the circular side walls are generally substantially shorter than the longitudinal dimension of the camera lens; and a generally hard insert adapted to be removably inserted into the generally circular end cap; wherein the camera lens cover is fabricated from a generally elastic material such that the elastic nature of the material serves to hold the lens cover in position after it is placed on the end of the camera lens.

### BRIEF DESCRIPTION OF THE DRAWINGS

FIG. 1 is a plan view of an embodiment of the present invention.

FIG. 2 is a plan view illustrating a component of the present invention.

FIG. 3 is a plan view of an embodiment of the present invention mounted on a camera lens.

### DETAILED DESCRIPTION OF THE INVENTION

The present invention will now be described in terms of the presently preferred embodiment thereof as illustrated in the drawings. Those of ordinary skill in the art will recognize that many obvious modifications may be made thereto without department from the spirit or scope of the present invention.

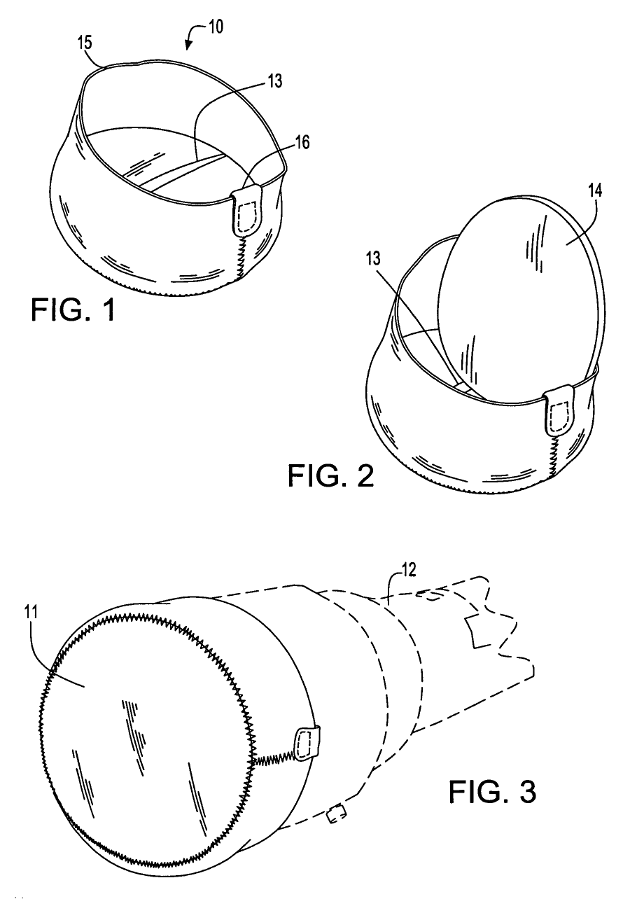

The lens cover 10 of the present invention is illustrated in the drawings. In FIG. 1, the lens cover 10 is generally circular in shape at its front end 11 and is adapted to fit securely over the front end of a camera lens 12. The lens cover 10 of the preferred embodiment is fabricated from Neoprene but can be fabricated from any suitable material with similar characteristics. FIG. 3 illustrates the lens cover 10 installed on the front of a camera lens. The height of the side walls of the lens cover 10 is relatively short compared to the length of a typical camera lens.

The front end 11 of the lens cover 10 comprises a slot 13 in the front thereof. The slot 13 is adapted to receive a hard plastic insert 14. The hard plastic insert 14 is adapted to protect the front element of the lens from damage from hard objects. However, the hard insert 14 is removable if the user desires.

The lens cover 10 further comprises a loop 16 on its back edge 15. The loop 16 is adapted to facilitate placement and removal of the lens cover 10 on the front of the camera lens.

The advantage of using neoprene or a similar material for fabrication of the lens cover 10 is the elasticity of the lens cover 10 that results. The lens cover 10 can be placed on the end of the camera lens or lens shade by stretching and then releasing the material so that the lens cover 10 will snap into position. The lens cover 10 will be held in place by its natural elasticity rather than by a drawstring or other prior methods of attachment.

When placed on the lens as shown in FIG. 3, the lens cover 10 protects the camera lens from dirt, moisture, dust or inadvertent impact.

Those of ordinary skill in the art will recognize that the foregoing merely represents one embodiment of the present invention and many modifications may be made thereto without departing from the spirit or scope of the present invention as set forth in the appended claims.

What is claimed is:

1. A removable camera lens cover adapted to cover the front element of a camera lens comprising:
a. a generally circular end cap;
b. circular side walls connected to the generally circular end cap wherein the circular side walls are generally substantially shorter than the longitudinal dimension of the camera lens; and
c. a generally hard insert adapted to be removably inserted into the generally circular end cap;
wherein the camera lens cover is fabricated from a generally elastic material such that the elastic nature of the material serves to hold the lens cover in position after it is placed on the end of the camera lens.
